(19) United States
(12) Patent Application Publication
(10) Pub. No.: US 2026/0064053 A1
(43) Pub. Date: Mar. 5, 2026

(54) FIXING DEVICE AND IMAGE FORMING APPARATUS

(71) Applicant: KYOCERA Document Solutions Inc., Osaka (JP)

(72) Inventor: Tatsuya YAMANAKA, Osaka (JP)

(73) Assignee: KYOCERA Document Solutions Inc., Osaka (JP)

(21) Appl. No.: 19/288,222

(22) Filed: Aug. 1, 2025

(30) Foreign Application Priority Data
Aug. 28, 2024 (JP) 2024-146105

(51) Int. Cl. G03G 15/20; G03G 15/00

(52) U.S. Cl. CPC G03G 15/2053; G03G 15/2064; G03G 15/80; G03G 2215/2035

(57) ABSTRACT

A fixing device includes a fixing belt, a planer heater, a heater holder, a connector, and an insulation sheet. The fixing belt is cylindrical. The planar heater generates heat when an electrode is powered. The heater holder supports the planar heater in contact with an inner peripheral surface of the fixing belt. The connector is attached along a direction along a surface of the planar heater so as to hold the heater holder and the planar heater, and has a contact terminal electrically connected to the electrode. The insulation sheet has an opening for passing the contact terminal and covers the electrode of the planar heater.

### INCORPORATION BY REFERENCE

This application is based on and claims the benefit of priority from Japanese patent application No.2024-146105 Aug. 28, 2024, which is incorporated by reference in its entirety.

### TECHNICAL FIELD

The present disclosure relates to a fixing device which heats and presses a toner image and fixed the toner image on a sheet and an image forming apparatus including the fixing device.

### BACKGROUND

A planar heater may be used as a heat source for heating the toner image in the fixing device. The planar heater may be supported on a heater holder by a pair of mounting members.

The planar heater generates heat by being powered through a connector. The connector is mounted along a direction along the surface of the planar heater so as to hold the heater holder and the planar heater, and the contact terminal is electrically connected to the electrode portion of the planar heater.

When the connector is mounted along the surface of the planar heater as described above, the contact terminal of the connector slides with respect to the electrode portion of the heater. In this case, the anti-sulfurization agent coated on the electrode portion may be scraped and peeled off by the contact terminal, or the contact terminal may be deformed, resulting in poor electric connection between the planar heater and the connector.

### SUMMARY

A fixing device according to the present disclosure includes a fixing belt, a planer heater, a heater holder, a connector, and an insulation sheet. The fixing belt is cylindrical. The planar heater generates heat when an electrode is powered. The heater holder supports the planar heater in contact with an inner peripheral surface of the fixing belt. The connector is attached along a direction along a surface of the planar heater so as to hold the heater holder and the planar heater, and has a contact terminal electrically connected to the electrode. The insulation sheet has an opening for passing the contact terminal and covers the electrode of the planar heater.

An image forming apparatus according to the present disclosure includes an image forming part which forms a toner image on a sheet; and the fixing device which fixes the toner image on the sheet.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a cross-sectional view schematically showing an internal configuration of an image forming apparatus according to one embodiment of the present disclosure.

FIG. 2 is a cross-sectional view schematically showing an internal configuration of a fixing device according to one embodiment of the present disclosure.

FIG. 3 is a perspective view showing a fixing belt assembly of the fixing device according to the embodiment of the present disclosure.

FIG. 4 is a perspective view showing a heater holder of the fixing belt assembly of the fixing device according to the embodiment of the present disclosure.

FIG. 5 is a perspective view showing a stopper and an insulation sheet in the fixing device according to the embodiment of the present disclosure.

FIG. 6 is a perspective view showing a stopper, the insulation sheet, and a connector in the fixing device according to the embodiment of the present disclosure.

### DETAILED DESCRIPTION

Hereinafter, with reference to the drawings, an image forming apparatus and a fixing apparatus according to one embodiment of the present disclosure will be described.

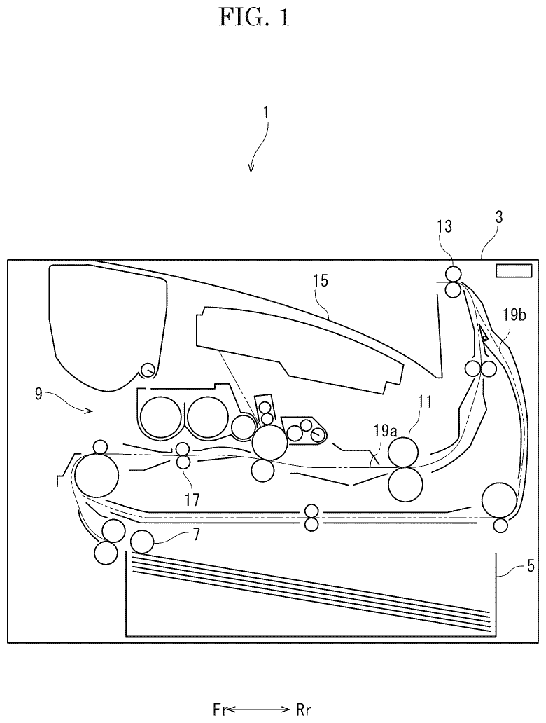

First, with reference to FIG. 1, the entire configuration of the image forming apparatus 1 will be described. FIG. 1 is a front view schematically showing the internal configuration of the image forming apparatus 1. The reference numerals Fr, Rr, L, R, Up, and Lo attached to the following drawings indicate the front, back, left, right, upper, and lower, respectively.

An apparatus main body 3 of then image forming apparatus 1 is provided with a sheet feeding cassette 5 in which the sheet is stored, a sheet feeding device 7 which feeds the sheet from the sheet feeding cassette 5, an image forming part 9 which forms a toner image on the sheet in an electrophotographic manner, a fixing device 11 which fixes the toner image on the sheet, a discharging device 13 which discharges the sheet, and a discharge tray 15 on which the discharged sheet is loaded. A pair of registration rollers 17 is disposed between the sheet feeding device 7 and the image forming part 9.

The sheet feeding cassette 5 is housed in a cassette housing part provided at the lower portion inside the apparatus main body 3. The sheet feeding device 7 is disposed above the front end of the cassette housing part. The pair of registration rollers 17 is disposed above the sheet feeding device 7. The image forming part 9 is disposed on the rear side of the pair of registration rollers 17. The fixing device 11 is disposed on the rear side of the image forming part 9. The discharging device 13 is disposed above the fixing device 11. The discharge tray 15 is provided on the upper surface of the apparatus main body 3.

Further, the apparatus main body 3 is formed with a main conveyance path 19a and a double-sided conveyance path 19b through which the sheet is conveyed. The main conveyance path 19a is formed along the conveyance direction from the sheet feeding device 7 to the discharging device 13 through the image forming part 9 and the fixing device 11. The double-sided conveyance path 19b is branched from the main conveyance path 19a on the downstream side of the fixing device 11 in the conveyance direction, and merged with the main conveyance path 19a on the upstream side of the pair of registration rollers 17 in the conveyance direction.

Next, an image forming operation will be briefly described. In the case of single-sided printing, the sheet fed from the sheet feeding cassette 5 by the sheet feeding device 7 is conveyed along the main conveying path 19a, and after the skew is corrected by the pair of registration rollers 17, the sheet is conveyed to the image forming part 9. In the image forming part 9, a toner image is formed on the sheet. The sheet on which the toner image is formed is conveyed to the fixing device 11 along the main conveying path 19a, and the toner image is fixed to the sheet in the fixing device 11. The sheet on which the toner image is fixed is discharged to the discharge tray 15 by the discharging device 13.

In the case of double-sided printing, the sheet on which the toner image is fixed on one side of the sheet by the fixing device 11 passes through the fixing device 11, is switched back, and conveyed to the double-sided conveyance path 19b. The sheet is conveyed along the main conveying path 19a via the double-sided conveyance path 19b. After the skew of the sheet is corrected by the pair of registration rollers 17, the toner image is formed to the other side of the sheet by the image forming part 9. The sheet on which the toner image has been transferred is conveyed to the fixing device 11 along the main conveyance path 19a, and the toner image is fixed to the other surface of the sheet in the fixing device 11. The sheet on which the toner image is fixed is conveyed along the main conveyance path 19a to the discharging device 13, and discharged to the discharge tray 15 by the discharging device 13.

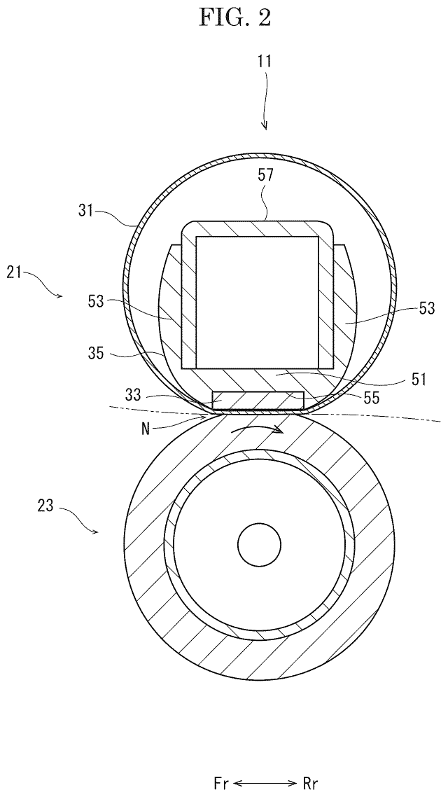

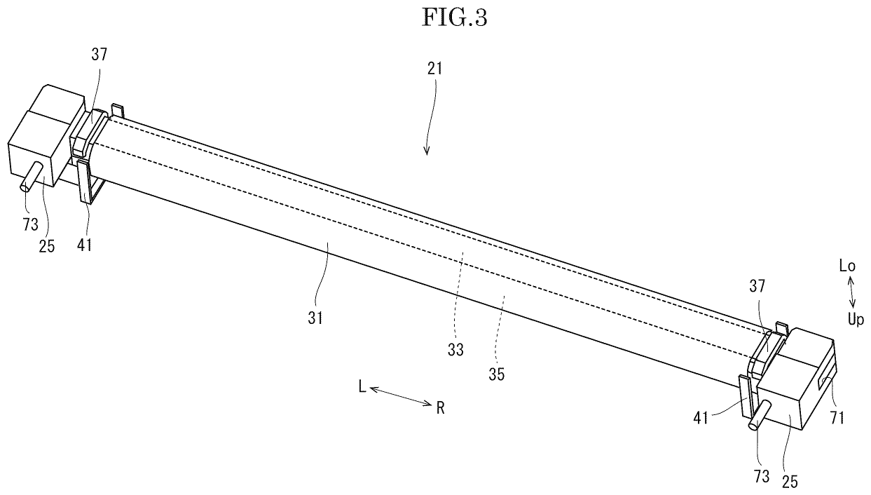

Next, the fixing device 11 will be described with reference to FIG. 2. FIG. 2 is a cross-sectional view showing the internal configuration of the fixing device 11. The fixing device 11 includes a belt assembly 21, a pressure roller 23, and two connectors 25 (not shown in FIG. 2, see FIG. 3).

First, the belt assembly 21 will be described with reference to FIG. 3. FIG. 3 is a perspective view showing the belt assembly 21. The belt assembly 21 includes a fixing belt 31, a heater 33 which heats the fixing belt 31, a heater holder 35 which holds the heater 33, two stoppers 37 which supports the heater 33 to the heater holder 35, an insulation sheet 39 fixed to the stopper 37, and right and left end holders 41 which supports the heater holder 35.

First, the fixing belt 31 will be described. The fixing belt 31 is formed in a cylindrical shape having a predetermined inner diameter and a width longer than the width of the sheet. The fixing belt 31 is made of flexible material, and has a base material layer, an elastic layer provided on the outer peripheral surface of the base material layer, and a release layer provided on the outer peripheral surface of the elastic layer. The base layer is made of resin. The elastic layer is made of silicon rubber or the like. The release layer is made of a PFA tube or the like.

Next, the heater 33 will be described. The heater 33 is a rectangular plate-shaped planar heater 33. The planar heater 33 has a base material, a heat insulating layer, a heating resistor layer, and a coating layer.

The base material has a rectangular plate shape having a length longer than the width of the fixing belt 31. The heat insulating layer is made of material having electrical insulation and low thermal conductivity, such as ceramics and glass, and is formed on one surface of the base material. The heating resistor layer is made of conductive material such as a metal having a high resistance value, and is laminated on the surface of the heat insulating layer. A length of the heating resistor layer (a length along the width direction of the fixing belt) is slightly longer than the width of the fixing belt 31 and shorter than the length of the base material. That is, no heating resistor layer is formed on both end portions of one surface of the base layer. Electrodes connected to the heating resistor layer are formed at both the end portions of one surface of the base layer. The electrode is coated with an anti-sulfurization agent. When the electrode is powered, the heating resistor layer generates heat. The coating layer is made of material having electrical insulation such as ceramics, and having a small sliding friction resistance to the fixing belt, and covers the heating resistor layer.

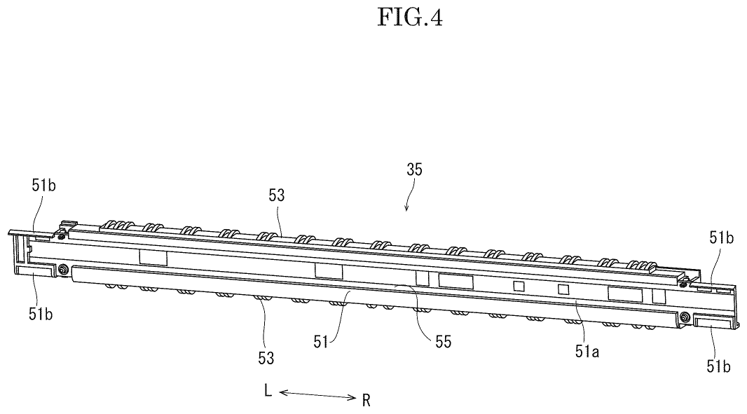

Next, the heater holder 35 will be described with reference to FIG. 4. FIG. 4 is a perspective view showing the heater holder 35. The heater holder 35 is formed in a substantially semi-cylindrical shape along the circumferential direction of the inner circumferential surface of the fixing belt 31, and has a width larger than the width of the fixing belt 31. The heater holder 35 has a flat part 51 and curved parts 53. The curved parts 53 are formed on both sides of the flat part 51 in the circumferential direction. A length of the flat part 51 is longer than a length of both curved parts 53. Therefore, both end portions of the flat part 51 protrude outward from the curved parts 53. On the outer surface 51a of the flat part 51, a recess 55 in which the planar heater 33 is housed is formed. The side surfaces 51b (side surfaces in the circumferential direction) of both the end portions of the flat part 51 are inclined toward the outer surface 51a of the flat part 51 so as to be close to each other (it is referred to as an inclined surface). The heater holder 35 is made of heat-resistant resin such as liquid crystal polymer.

As shown in FIG. 2, the heater holder 35 is mounted to the lower surface of a stay 57 passing through the hollow space of the fixing belt 31.

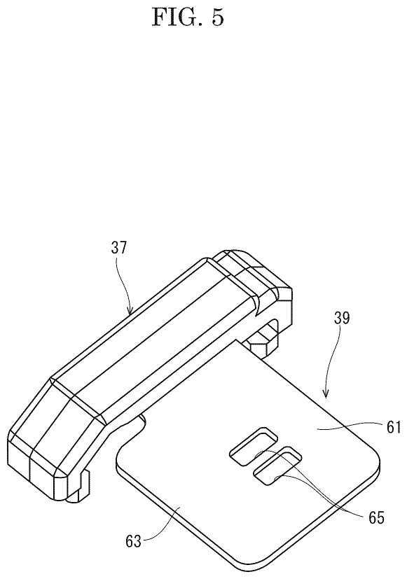

Next, the stopper 37 will be described with reference to FIG. 5. FIG. 5 is a perspective view showing the stopper 37 and the insulation sheet 39. The stopper 37 holds the end portions of the planar heater 33 housed in the recess 55 of the heater holder 35 to the heater holder 35. The stopper 37 has a curved shape along the outer surface 51a and both the inclined surfaces 51b of the end portion of the flat part 51 of the heater holder 35. The stopper 37 is made of resin. The stopper 37 can be mounted to the end portion of the flat part 51 of the heater holder 35 by being elastically deformed.

Next, the insulation sheet 39 will be described with reference to FIG. 5. The insulation sheet 39 is provided integrally with the stopper 37. The insulation sheet 39 is made of material having electrical insulation and good heat resistance (for example, polyimide), and has a substantially rectangular shape. A thickness of the insulation sheet 39 is 0.1 to 0.2 mm.

The insulation sheet 39 has a body part 61 and a free end part 63. The body part 61 has a rectangular shape larger in size than the electrode of the planar heater 33. One side edge of the body part 61 is mounted to the stopper 37. Two openings 65 are formed in the center of the body part 61. The free end part 63 extends from a side edge (one side edge in the circumferential direction) adjacent to the side edge mounted to the stopper 37. The free end part 63 is not mounted to the stopper 37. Each corner of the insulation sheet 39 is rounded in an arc shape.

The planar heater 33 housed in the recess 55 of the heater holder 35 is held to the heater holder 35 by the stopper 37 as described above. Specifically, the end portion of the planar heater 33 (the portion between the heating resistor layer and the electrode) is held between the stopper 37 and the recess 55. Thus, the planar heater 33 is housed the recess 55, and movement in the longitudinal direction (the width direction of the fixing belt 31) and the direction crossing the longitudinal direction (the circumferential direction of the fixing belt 31) is restricted.

When the planar heater 33 is held to the heater holder 35 by the stopper 37 in this manner, the body part 61 of the insulation sheet 39 is in contact with the upper surface of the electrode, and the free end part 63 covers the upper space of the inclined surface 51b of the end portion of the flat part 51. The electrode of the planar heater 33 is exposed from the openings 65 of the body part 61.

Next, the right and left end holders 41 will be described. Each end holder 41 supports one end of the fixing belt 31 and one end of the stay 57. The left and right end holders 41 are supported by the left and right side plates of the fixing housing (not shown) via pressure changing parts (not shown).

Next, the pressure roller 23 will be described. The pressure roller 23 has a rotational shaft, an elastic layer provided on the outer peripheral surface of the rotational shaft, and a release layer provided on the outer peripheral surface of the elastic layer.

Both end portions of the rotational shaft of the pressure roller 23 are rotatably supported on the left and right side plates of the fixing housing below the belt assembly 21. The pressure roller 23 faces the planar heater 33 across the fixing belt 31 of the belt assembly 21. Thus, a fixing nip N is formed between the fixing belt 31 and the pressure roller 23. A drive gear (not shown) is mounted to one end of the rotational shaft of the pressure roller 23. The drive gear is connected to a motor (not shown) via a gear train (not shown).

When the motor is driven, the drive gear rotates in the clockwise direction of FIG. 2 (see the arrow in FIG. 2) via the gear train, and the pressure roller 23 rotates in one direction (in the clockwise direction in this example). Then, the fixing belt 31 in contact with the pressure roller 23 at the fixing nip N rotates in the other direction (in the counterclockwise direction in this example). Thus, the sheet is conveyed through the fixing nip N.

Next, the connector 25 will be described. As shown in FIG. 3, a recess 71 is formed on one end surface of the connector 25 along the longitudinal direction of the connector. Two contact terminals are supported on opposite sides of the recess 71. Each contact terminal is an arcuate plate spring-like member along the longitudinal direction, and can be elastically deformed into a flat shape by being pushed in. Each contact terminal is connected to a power source via a wiring 73.

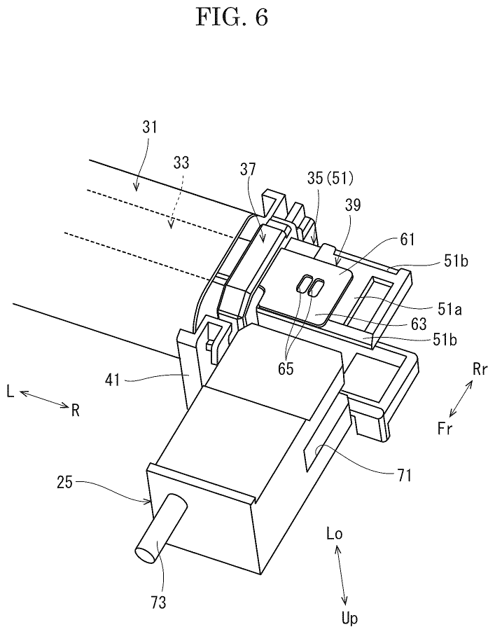

In the fixing device 11 having the above configuration, a process of connecting the connector 25 to the electrode of the planar heater 33 will be described with reference to FIG. 6. FIG. 6 is a perspective view showing the stopper 37, the insulation sheet 39, and the connector 25 viewed from below.

The connector 25 is attached to the heater holder 35 (the end portion of the flat part 51) along a direction (in this example, the conveyance direction, from the front side to the rear side) along the surface of the planar heater 33. Specifically, the connector 25 is attached to the side where the free end part 63 of the insulation sheet 39 is provided, with the end surface having the recess 71 first. As the connector 25 is attached in this manner, the end portion of the flat part 51 of the heater holder 35 starts to be inserted into the recess 71 of the connector 25.

When the end portion of the flat part 51 of the heater holder 35 is inserted into the recess 71 of the connector 25, the contact terminal of the connector 25 is first into contact with the free end part 63 of the insulation sheet 39. The contact terminal slides from the free end part 63 to the body part 61 while being elastically deformed by being pushed by the insulation sheet 39. When the contact terminal eventually reaches the openings 65 of the body part 61, the contact terminal elastically returns and is electrically connected to the electrode of the planar heater 33 through the openings 65. Thus, power can be supplied to the planar heater 33 via the connector 25.

As described above, according to the present disclosure, when the connector 25 is attached to the heater holder 35, the contact terminal of the connector 25 moves along the upper surface of the insulation sheet 39, so that the electrode does not come into contact with the contact terminal. As described above, since the electrode is not scraped by the contact terminal when the connector 25 is attached/detached, abrasion and scraping of the electrode can be suppressed, and the power can be reliably supplied to the planar heater 33 via the connector 25.

Further, since the contact terminal slides from the free end part 63 of the insulation sheet 39 to the body part 61 when the connector 25 is attached, the contact terminal can be guided to the electrode without being caught by the inclined surface 51b of the heater holder 35.

The attachment direction of the connector 25 is not limited to the above-described direction, but may be an opposite direction or a direction perpendicular to each other. Also in this case, since the electrode is covered with the body part 61 of the insulation sheet 39, the electrode does not come into contact with the contact terminal when the connector 25 is attached.

The insulation sheet 39 is not necessarily provided integrally with the stopper 37. For example, the insulation sheet 39 may be mounted on the electrode with an adhesive. Alternatively, a holding portion may be provided adjacent to the body part 61 of the insulation sheet 39, and the holding portion may be held between the heater holder 35 and the stopper 37. The stopper 37 and the heater holder 35 may be provided with projections or openings for engaging with each other. In this case, since the stopper 37 can be securely attached to the heater holder 35 by engaging the two, the planar heater 33 can be positioned more accurately.

The insulation sheet 39 is preferably made of material having better slidability than the electrode. In this case, the resistance between the contact terminal and the insulation sheet 39 when the connector 25 is attached can be reduced.

While the present disclosure has been described for specific embodiments, the present disclosure is not limited to those embodiments. A person skilled in the art may modify the above embodiments without departing from the scope and spirit of the present disclosure.

1. A fixing device comprising:
a cylindrical fixing belt;
a planar heater which generates heat when an electrode is powered;
a heater holder which supports the planar heater in contact with an inner peripheral surface of the fixing belt;
a connector which is attached along a direction along a surface of the planar heater so as to hold the heater holder and the planar heater, and has a contact terminal electrically connected to the electrode; and
an insulation sheet which has an opening for passing the contact terminal and covers the electrode of the planar heater.

2. The fixing device according to claim 1, comprising:
a stopper which mounts and positions the planar heater to the heater holder, wherein
the insulation sheet is provided integrally with the stopper.

3. The fixing device according to claim 1, comprising:
a stopper which mounts and positions the planar heater to the heater holder, wherein
the insulation sheet is held between the stopper and the heater holder and supported.

4. The fixing device according to claim 1, wherein
the heater holder includes:
a recess in which the planar heater is housed, and
an inclined surface inclined toward the recess from an upstream side in an attachment direction of the connector, and
the insulation sheet includes:
a body part covering the electrode of the planar heater, and
a free end part extending from the body part above the inclined surface toward the upstream side in the attachment direction.

5. The fixing device according to claim 1, wherein
the insulation sheet is made of material having better slidability than the electrode of the planar heater.

6. An image forming apparatus comprising:
an image forming part which forms a toner image on a sheet; and
the fixing device according to claim 1, which fixes the toner image on the sheet.
